(19) United States
(12) Patent Application Publication
(10) Pub. No.: US 2006/0282838 A1
(43) Pub. Date: Dec. 14, 2006

(54) MPI-aware networking infrastructure

(76) Inventors: Rinku Gupta, Austin, TX (US); Timothy Abels, Pflugerville, TX (US)

Correspondence Address: HAMILTON & TERRILE, LLP, P.O. BOX 203518, AUSTIN, TX, 78720, US

(21) Appl. No.: 11/147,783

(22) Filed: Jun. 8, 2005

(51) Int. Cl. G06F 9/46

(52) U.S. Cl. 719/313

(57) ABSTRACT

The present invention provides for reduced message-passing protocol communication overhead between a plurality of high performance computing (HPC) cluster computing nodes. In particular, HPC cluster performance and MPI host-to-host functionality, performance, scalability, security, and reliability can be improved. A first information handling system host, and its associated network interface controller (NIC) is enabled with a lightweight implementation of a message-passing protocol, which does not require the use of intermediate protocols. A second information handling system host, and its associated NIC is enabled with the same lightweight message-passing protocol implementation. A high-speed network switch, likewise enabled with the same lightweight message-passing protocol implementation, interconnected to the first host and the second host, and potentially to a plurality of like hosts and switches, can create an HPC cluster network capable of higher performance and greater scalability.

### BACKGROUND OF THE INVENTION

1. Field of the Invention

The present invention relates in general to the field of information handling systems and more specifically, to management of message passing protocols.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, an how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

The demand for more powerful information handling systems has historically driven computing technology advances and innovation, with economic dynamics concurrently driving the need for cost effectiveness. Various efforts to increase computing power at a lower cost have involved using multiple processors, working in parallel, driven by a common set of command instructions. For example, symmetric multiprocessing (SMP) can use as few as two processors working in parallel, with massively parallel processing (MPP) computing models scaling up to using hundreds of processors.

Earlier high performance computing (HPC) solutions were designed with multiple processors comprising a single system. Later efforts resulted in the concept of an HPC cluster, a parallel computing architecture featuring multiple SMP nodes interconnected by a high-speed private network system, capable of achieving the raw computing power commonly associated with “supercomputers.”These clusters work in tandem to complete a single request by dividing the work among the SMP nodes, reassembling the results and presenting them as if a single-system did the work. The SMP nodes in the cluster can be commodity systems (e.g., personal computers, workstations, servers, etc.), which generally run commodity operating system software (e.g., Windows, Linux, etc.).

The high-speed interconnect, along with its associated communication protocols, comprises the communication link that transforms a group of SMP computers into an HPC cluster with the ability to execute parallel applications. These parallel applications are commonly executed through a message passing, parallel computing model. Message Passing Interface (MPI) is one such model, with others including Parallel Virtual Machine (PVM) and Aggregate Remote Memory Copy Interface (ARMCI), and any similar message passing library. Currently, MPI and PVM are the most frequently used tools for parallel computing based on the message-passing paradigm. The method in which they are implemented can have a significant impact on the HPC cluster's performance.

Myrinet is an industry standard (ANSI/VITA 26-1998) implementation of MPI that provides low-latency, high-bandwidth, end-to-end communication between two nodes in an HPC cluster. It is a connectionless interconnect implementing packet-switching technologies used in experimental MPP networks. Myrinet offers advanced mechanisms for efficient communication through its GM message-passing system.

Lightweight communication protocols such as GM are more efficient for HPC interconnects than the more conventional TCP/IP protocol. Lightweight protocols allow applications to communicate with the network interface controller (NIC) directly, which reduces the message-passing overhead and avoids unnecessary data copies in the operating system. As a result, this type of protocol enables lower communication latency and higher throughput.

Currently, HPC interconnect traffic is typically routed between computing nodes via NIC cards that support MPI or PVM and implement lightweight protocols. Many of these NIC cards include a programmable processor, allowing much of the MPI matching semantics to be off-loaded from the host processor.

However, current NIC processors may be up to an order of magnitude slower than their host processor counterparts, which can limit the amount of the MPI stack that can be offloaded. As NIC processors improve, more of the MPI stack will be absorbed, further reducing communications overhead and realizing significant throughput improvements. While network interface processors are slow relative to host processors, their proximity to the network make them adequate to accelerate some portion of the protocol stack.

As networks increase in performance and the disparity between the host and network processor speed is reduced, a richer set of network processing semantics will be required to deliver raw network performance. Currently, HPC cluster performance can deteriorate when interconnect traffic is intensive between computing nodes, due to the communications overhead resulting from the processing of the MPI protocol stack at each switch node within the network. This communication overhead can limit MPI host-to-host scalability, driving a corresponding requirement for the same network processing semantics in the MPI-enabled switches that comprise an HPC cluster network.

What is required is a message passing protocol solution that accelerates MPI protocol processing, not just at a computing node's NIC, but also at the switch nodes in a HPC cluster network.

### SUMMARY OF THE INVENTION

The present invention provides a method and apparatus that can accelerate the processing of message passing protocols for a plurality of nodes comprising a High Performance Computing (HPC) cluster network. In particular, the invention can reduce or remove the need for intermediate protocols (e.g., TCP) when processing message-passing protocols (e.g. MPI) at both the network interface controller (NIC) of computing nodes and the high-speed interconnect switch nodes of a HPC cluster network.

In one embodiment of the invention, MPI-enabled NICs and MPI-enabled network switches, each of which is comprised of a lightweight implementation of MPI primitives, are aware of each other's presence within an HPC cluster network. These MPI-enabled NICs and network switches, embodying various methods of the present invention, will be referred to as “MPI-aware” hereinbelow.

In this same embodiment, the MPI-aware switch can be used for collective operations between a selected group of MPI-aware HPC computing nodes. For example, an MPI-aware NIC accepts a payload of parallel applications and/or data examines the payload for routing information, and wraps the message with an MPI packet header and footer, which includes the source ID of the payload, and sends it to an MPI-aware switch. The MPI-aware switch, which is cognizant of the MPI-aware NIC, accepts the MPI-wrapped message and forwards it to its intended destination node within the MPI-aware HPC cluster network.

In another embodiment of the invention, the MPI-aware switch can act as an intelligent, cache-based HPC appliance in the center of the MPI-aware HPC cluster network.

In yet another embodiment of the invention, the MPI-aware switch can forward data to the intended destinations from the cache, thereby freeing the originating MPI-aware host processor for other operations.

In another embodiment of the invention, the MPI-aware switch can receive a single, MPI-wrapped message, remove the message header, examine the payload to parse a list of MPI-aware HPC nodes to broadcast the payload to, construct multiple new MPI-wrapped messages, and then broadcast them to the intended MPI-aware HPC node destinations.

In another embodiment of the invention, the MPI-aware switch can act as a translator between different MPI implementations at different MPI-aware HPC cluster network nodes.

Those of skill in the art will understand that many such embodiments and variations of the invention are possible, including but not limited to those described hereinabove, which are by no means all inclusive.

Use of the method and apparatus of the invention can result in reduced message-passing protocol communication overhead when interconnect traffic is intensive between computing nodes, which can improve HPC cluster performance and MPI host-to-host scalability.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention.

FIG. 2 is a generalized illustration of the components comprising one implementation of an HPC cluster.

FIG. 3 is a generalized illustration of the components comprising one implementation of an HPC cluster using an embodiment of the present invention.

FIG. 4 is a generalized illustration of one embodiment of a MPI communications stack implementation.

FIG. 5 is a generalized illustration of one embodiment of an MPI communications stack implementation enabling an HPC cluster through the use of intermediate protocols.

FIG. 6 is a generalized illustration of one embodiment of the present invention enabling HPC cluster operations using a message passing protocol with or without the use of intermediate protocols.

FIG. 7 is a generalized illustration of one embodiment of the present invention enabling MPI-wrapped message exchanges between an MPI-aware host and an MPI-aware switch.

FIG. 8 is a generalized illustration of one embodiment of the present invention enabling a variety of HPC cluster operations through the use of an MPI-aware switch.

### DETAILED DESCRIPTION

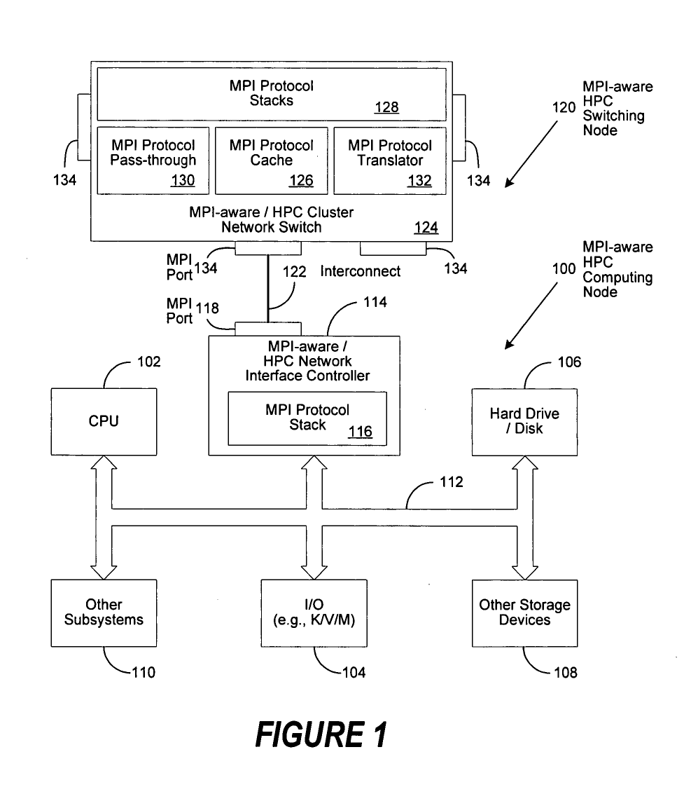

FIG. 1 is a generalized illustration of an information handling system 100 that can be used to implement the method and apparatus of the present invention. The information handling system includes a processor 102, input/output (I/O) devices 104, such as a display, a keyboard, a mouse, and associated controllers, a hard disk drive 106 and other storage devices 108, such as a floppy disk and drive and other memory devices, and various other subsystems 110, all interconnected via one or more buses 112.

In an embodiment of the present invention, information handling system 100 can be enabled as an MPI-aware HPC computing node through implementation of an MPI-aware HPC Network Interface Controller (NIC) 114 comprising an MPI protocol stack 116 and an MPI port 118. A plurality of resulting MPI-aware HPC computing nodes 100 can interconnect cable 122 with a plurality of MPI-aware HPC Switching Nodes 120 (e.g., an HPC cluster network switch), to transform a group of symmetrical multi-processor (SMP) computers into an HPC cluster with the ability to execute parallel applications.

In this embodiment of the invention, MPI-aware HPC Switch 124 is comprised of an MPI protocol cache 126, a plurality of complementary MPI protocol stacks 128, an MPI protocol pass-through 130, an MPI protocol translator 132, and an MPI port 134. As will be discussed in greater detail herein below, the interconnect 122 can be established by implementing a connection between an MPI port 118 of an HPC computing node 114 through an interconnect cable 122, to an MPI port 134 of an HPC switching node 120.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example, an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

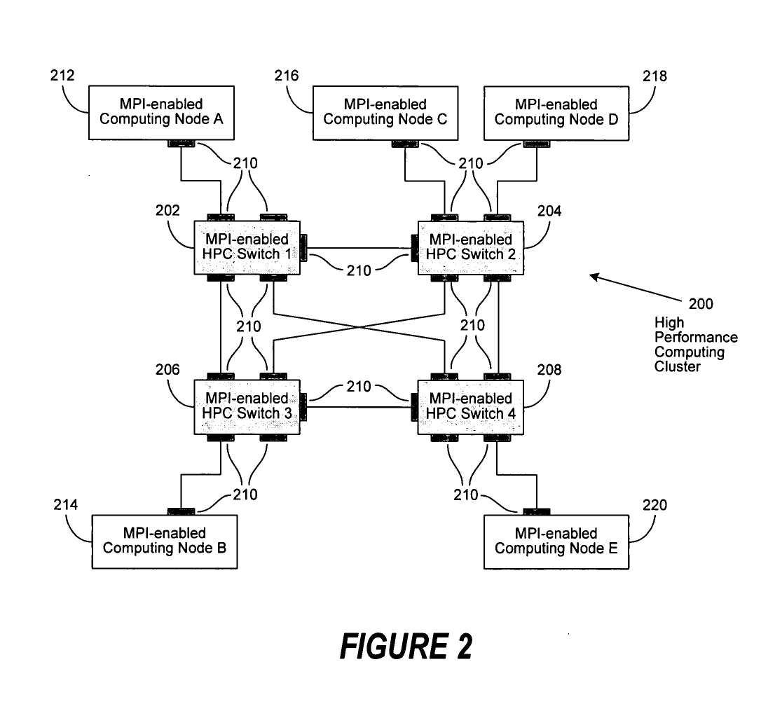

FIG. 2 is a generalized illustration of the components comprising one implementation of an HPC cluster 200 using MPI-enabled HPC switches. In this implementation, a plurality of MPI-enabled HPC switches 202, 204, 206, 208 are interconnected through their respective MPI ports 210 to create a network capable of enabling an HPC cluster. In this same implementation, a plurality of MPI-enabled computing nodes 212, 214, 216, 218, 220 are interconnected via their respective MPI ports 210 to a like MPI port 210 of an MPI-enabled HPC switch, thereby enabling an HPC cluster. Note that in this implementation, MPI-enabled computing nodes 212, 214, 216, 218, 220 are restricted to the same MPI variant (e.g., MPI/Pro, MPICH, WMPI, MPI-NT, etc.) and no inter-node MPI translation capabilities are enabled.

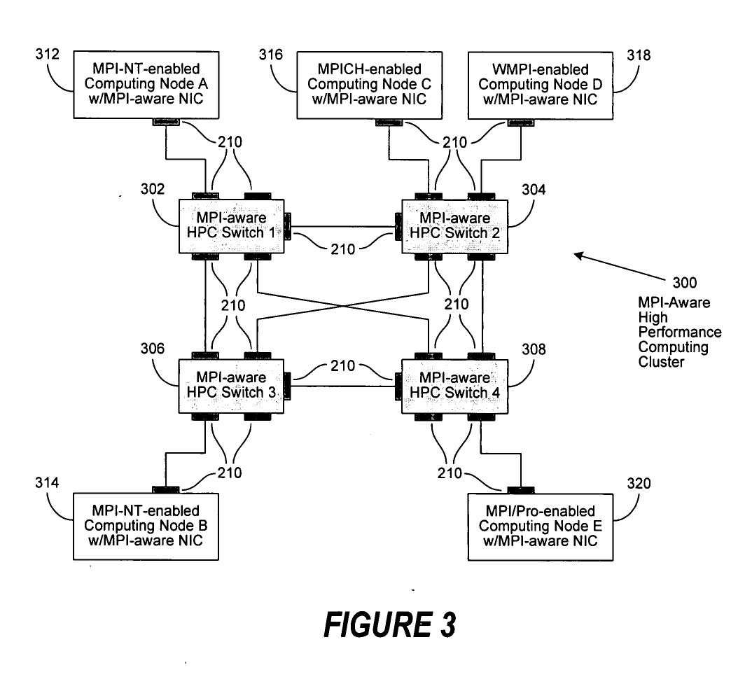

FIG. 3 is a generalized illustration of the components comprising one implementation of an HPC cluster using an embodiment of the present invention. In this embodiment, a plurality of MPI-aware HPC switches 302, 304, 306, 308, are interconnected through their respective MPI ports 210 to create a network capable of enabling an HPC cluster. In this same embodiment of the invention, a plurality of HPC computing nodes 312, 314, 316, 318, 320, are enabled with MPI-aware network interface controllers (NICs), which are coupled to their respective MPI ports 210. The plurality of MPI-aware HPC computing nodes 312, 314, 316, 318, 320, can be interconnected to the plurality of MPI-aware HPC switches 302, 304, 306, 308, all through their respective MPI ports 210, to create an HPC cluster. Note that in this embodiment of the invention, MPI-aware HPC computing nodes 312, 314, 316, 318, 320, are cognizant of the existence of MPI-aware HPC switches 302, 304, 306, 308, and each other. Furthermore, MPI-aware HPC switches 302, 304, 306, 308 are cognizant of the MPI variant enabled respectively on MPI-aware HPC computing nodes 312,314,316,318, 320.

For example, MPI-aware HPC switches 302, 304, 306, 308 understand that MPI-aware HPC computing node ‘A’ 312 is enabled with an MPI-aware NIC and an MPI-NT protocol stack that communicates with each other. Similarly, MPI-aware HPC switches 302, 304, 306, 308 understand that MPI-aware HPC computing node ‘B’ 314 is also enabled with a MPI-NT protocol stack, but MPI-aware HPC computing node ‘C’ 316 is enabled with an MPICH protocol stack, MPI-aware HPC computing node ‘D’ 318 is enabled with a WMPI protocol stack, and MPI-aware HPC computing node ‘E’ 320 is enabled with an MPI/protocol stack, all of which communicate with their associated MPI-aware NICs. In one embodiment of the invention, MPI-aware HPC switches 302, 304, 306, 308, can be cognizant of the MPI protocol stack variant enabling each MPI-aware HPC computing nodes 312, 314, 316, 318, 320, and as described in more detail hereinbelow, can then translate incoming MPI packets to the MPI protocol stack variant enabled at their destination MPI-aware HPC computing nodes 312, 314, 316, 318, 320.

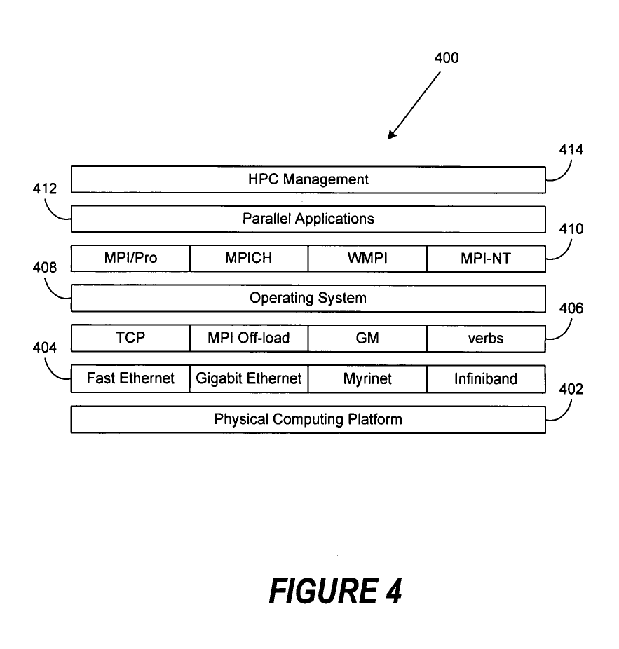

FIG. 4 is a generalized illustration of a message passing interface (MPI) protocol stack 400. In general, an MPI stack 400 is comprised of multiple layers, including a physical computing platform (e.g., Intel/AMD, Sun, IBM, etc.) 402, an interconnect layer (e.g., Fast Ethernet, Gigabit Ethernet, Infiniband, Myrinet, etc.) 404, a protocol layer (e.g., TCP, “verbs”, GM, MPI Off-load, etc.) 406, an operating system layer (e.g., Windows, Linux, etc.) 408, a message passing middleware layer (e.g., MPI/Pro, MPICH, WMPI, MPI-NT, etc.), a parallel applications layer 412, and an HPC management layer 414.

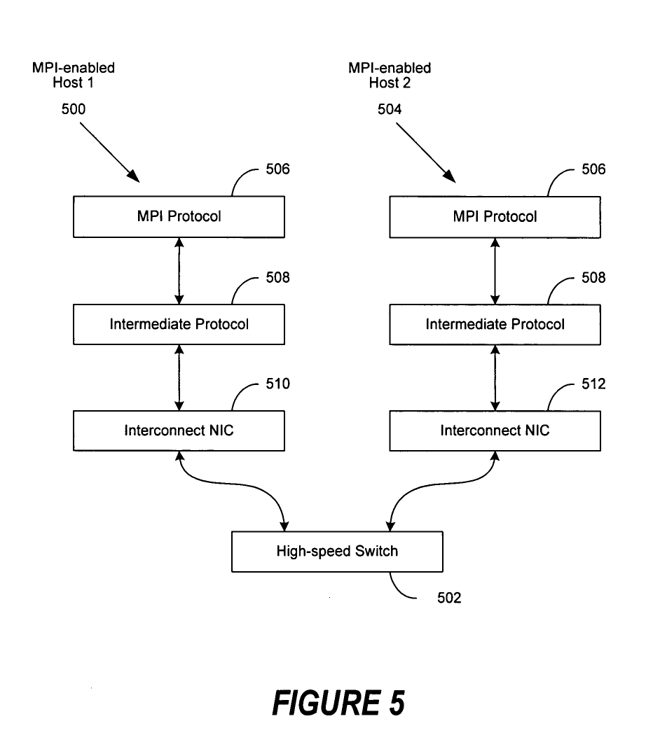

FIG. 5 is a generalized illustration of one embodiment of an MPI communications stack implementation enabling two host computers to perform HPC cluster operations through the use of intermediate protocols. In this embodiment, a first MPI-enabled host 500 communicates through a high-speed switch 502 to interact with a second MPI-enabled host 504 to perform parallel operations. For the first MPI-enabled host 500 to interact with the second MPI-enabled host 504, an MPI protocol library (e.g., MPI/Pro, MPICH, WMPI, MPI-NT) 506 makes calls to an intermediate protocol library (e.g., TCP, GM) 508, which interfaces to an interconnect NIC 510.

The interconnect NIC 510 of the first MPI-enabled host 500 is attached to a high-speed switch 502, which conveys parallel applications and/or data to the interconnect NIC 512 of the second MPI-enabled host 504. The interconnect NIC 512 of the second MPI-enabled host 504 interfaces to an intermediate protocol library (e.g., TCP, GM, verbs, etc.) 508 which makes calls to an MPI protocol library (e.g., MPI/Pro, MPICH, WMPI, MPI-NT, etc.) 506, thereby establishing bi-directional interaction between the two MPI-enabled hosts 500 and 506.

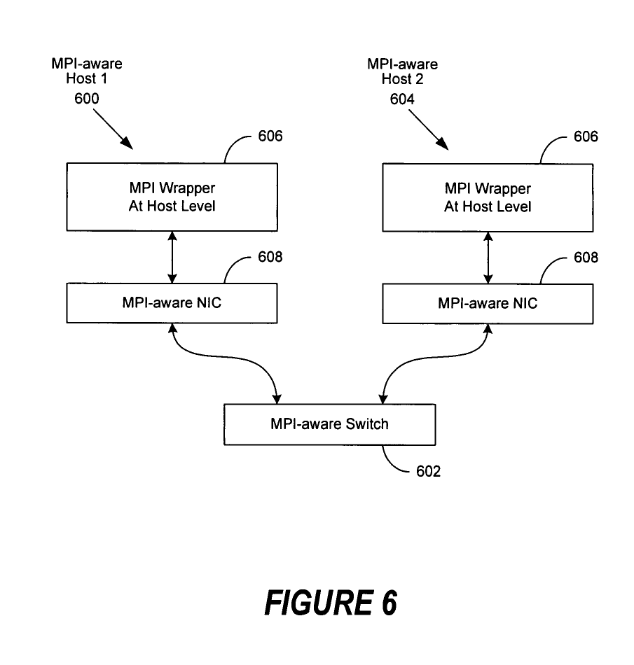

FIG. 6 is a generalized illustration of one embodiment of the present invention enabling two MPI-aware host computers to perform HPC cluster operations using a message passing protocol with or without the use of intermediate protocols. In this embodiment, a first MPI-aware host 600 initiates an HPC operation message which invokes a thin wrapper of MPI primitives 606 that can transfer host-based MPI instructions to an MPI-aware NIC 608. The payload of the message contains parallel applications and/or data to be enacted upon, the identity of the HPC operation, all potential HPC nodes and processes to be involved in the HPC operation, and the IDs assigned to each of those HPC nodes and processes.

The MPI-aware NIC 608 accepts the MPI-wrapped message, examines the payload for routing information, and wraps the message with an MPI packet header and footer, which includes the source ID of the payload and the appropriate destination HPC node IDs. The resulting MPI-wrapped message is then conveyed by the MPI-enabled NIC 608 to an MPI-aware switch 602. The MPI-aware switch 602 accepts the MPI-wrapped message, examines the header information, and routes it to the MPI-aware NIC 608 of the second MPI-aware host 606. The second MPI-aware host 606 accepts the MPI-wrapped message from its associated MPI-aware NIC 608, removes the MPI wrappers, and enacts on the payload of parallel applications and/or data, thereby establishing HPC cluster operations.

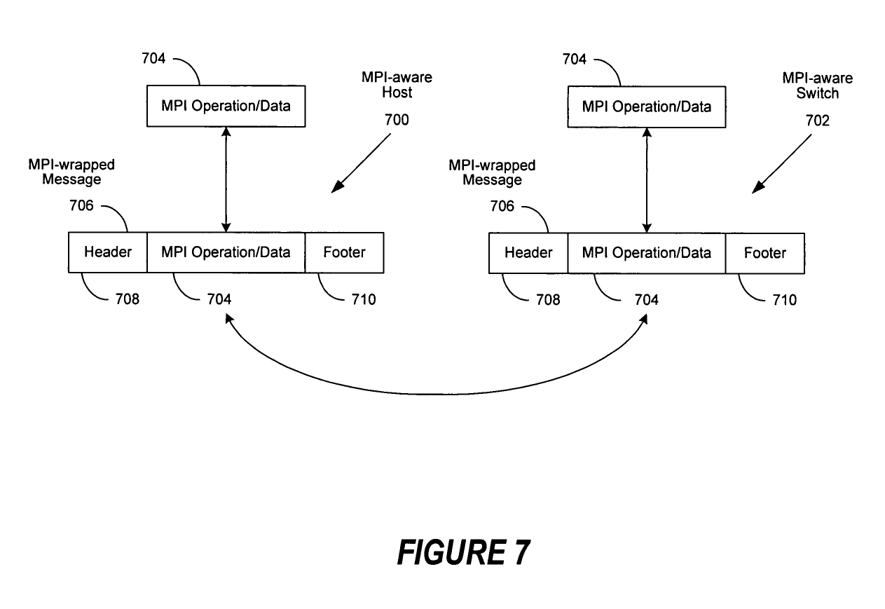

FIG. 7 is a generalized illustration of one embodiment of the present invention enabling an MPI-wrapped message exchange between an MPI-aware host and an MPI-aware switch. In this embodiment, an MPI-aware host 700 wraps a payload 704 containing parallel applications and/or data to be enacted upon, the identity of the HPC operation, all potential MPI-aware HPC nodes and processes to be involved in the HPC operation, and the IDs assigned to each of those MPI-aware HPC nodes and processes, with a MPI header 708 and MPI footer 710 to create an MPI-wrapped message 706. Skilled practitioners in the art will understand that many different MPI message packet structures can be supported in various embodiments of the invention. For example, the MPI message can be a fixed length or it could be base-address-plus-length. These examples are not all inclusive, and many others are possible.

The resulting MPI-wrapped message 706 is then conveyed to an MPI-aware switch 702 which accepts the MPI-wrapped message, removes the MPI wrapper, examines the payload for instructions, and then enacts as instructed on the payload of parallel applications and/or data, thereby establishing HPC cluster operations. As will be described in more detail hereinbelow, multiple operations on the payload are possible.

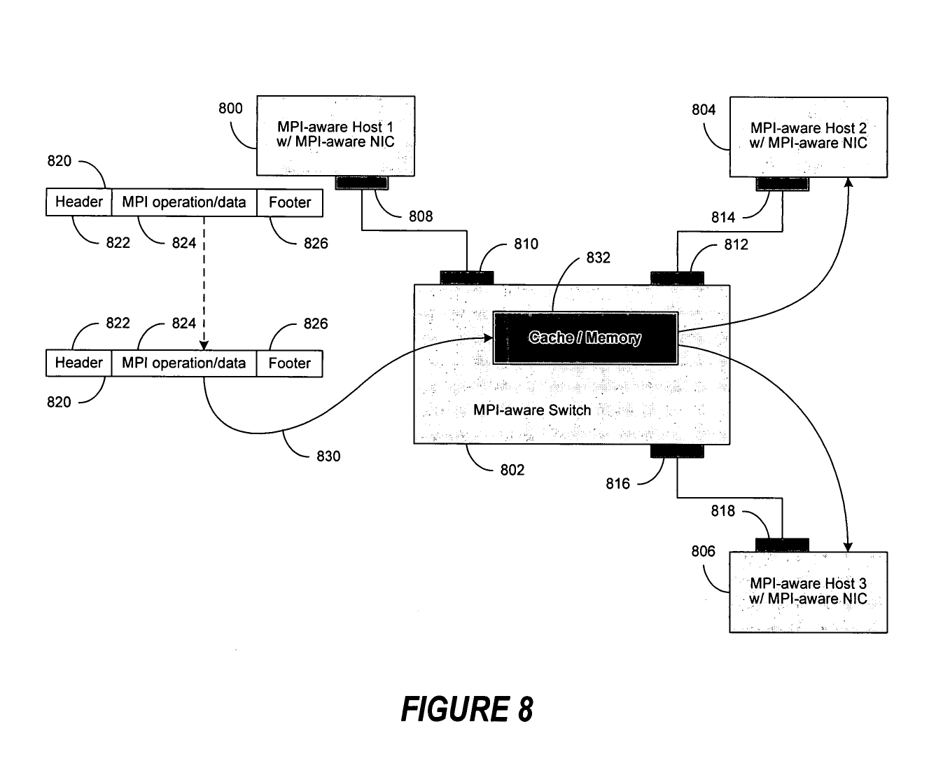

FIG. 8 is a generalized illustration of one embodiment of the present invention enabling a plurality of MPI-aware host computers to perform multiple HPC cluster operations, in concert with an MPI-aware switch, using a message passing protocol with or without the use of intermediate protocols.

In this embodiment a first MPI-aware host 800 is comprised of an MPI-aware NIC 808 which is connected to an MPI-enabled port 810 of an MPI-aware switch 802, a second MPI-aware host 804 is comprised of an MPI-aware NIC 814 which is connected to an MPI-enabled port 812 of an MPI-aware switch 802, and a third MPI-aware host 806 is comprised of an MPI-aware NIC 818 which is connected to an MPI-enabled port 816 of a MPI-aware switch 802.

In this same embodiment, the MPI-aware switch 802 comprises a processor, memory, a cache, and a lightweight MPI implementation, and transfers data when it arrives at an MPI-enabled port to the correct destination. In this same embodiment, MPI-aware host 800 wraps a payload 824 containing parallel applications and/or data to be enacted upon, the identity of the HPC operation, all potential HPC nodes and processes to be involved in the HPC operation, and the IDs assigned to each of those MPI-aware HPC nodes and processes, with a MPI header 822 and MPI footer 826 to create a MPI-wrapped message 820.

The resulting MPI-wrapped message 820 is then conveyed to an MPI-aware switch 802 which accepts the MPI-wrapped message, removes the MPI wrapper, stores the resulting payload in its cache and/or memory, examines the payload for instructions, and then enacts as instructed on the payload of parallel applications and/or data, thereby establishing HPC cluster operations.

Those who are skilled in the art will note that in this embodiment, all MPI-aware NICs are cognizant of the MPI-aware switch 802. Furthermore, the MPI-aware switch can keep track of all connected MPI-aware HPC nodes 800, 804, 806, and can monitor operating condition of their associated MPI-aware NICs 808, 814, 818. Specifically, the MPI-aware switch can discover the various MPI-aware HPC nodes using a plurality of techniques including: 1) by conducting a protocol sweep, 2) by analyzing a network table, or 3) by analyzing subnet parameters. The monitoring techniques can include 1) performance monitoring, 2) analyzing alerts and related event logs, or 3) using an agent to monitor the operating condition.

Those who are skilled in the art will understand the various ways that a MPI-aware switch 802 can monitor connected MPI-aware HPC nodes 800, 804, 806. For example, Routing Information Protocol (RIP), a distance vector routing algorithm, is one such approach, whereby routing tables can be maintained and managed.

Simple Network Management Protocol (SNMP) is another approach where the status and health of a plurality of MPI-aware HPC nodes 800, 804, 806, as well as a plurality of MPI-aware switches 802 can be monitored for operational status, performance and health.

Many such approaches can be implemented on MPI-aware switches 802, of which the examples given hereinabove are representative, but not all-inclusive.

In various embodiments of the invention, the MPI-aware switch 802 can be used for collective operations, which can be used between a selected group of HPC computing nodes. In other embodiments of the invention, the MPI-aware switch 802 can act as an intelligent, cache-based HPC appliance in the center of the HPC network.

In an embodiment of the invention, the MPI-aware switch 802 can forward data to the intended destinations from the cache, thereby freeing the originating MPI-enabled host processor for other operations. In this embodiment, the MPI-aware switch 802 can notify the originating MPI-enabled host that data has been successfully forwarded to the intended HPC node destination.

In yet another embodiment of the invention, the MPI-aware switch 802 can receive a single, MPI-wrapped message, remove the message header, examine the payload to parse a list of MPI-aware HPC nodes to broadcast the payload to, construct multiple new MPI-wrapped messages, and then broadcast them to the intended MPI-aware HPC node destinations.

For example, a first MPI-aware host 800 wraps a payload 824 containing parallel applications and/or data to be enacted upon, the identity of the HPC operation, all potential MPI-aware HPC nodes and processes to be involved in the HPC operation, and the IDs assigned to each of those MPI-aware HPC nodes and processes, with an MPI header 822 and MPI footer 826 to create an MPI-wrapped message 820. The resulting MPI-wrapped message 820 is then conveyed to an MPI-aware switch 802 which accepts the MPI-wrapped message, removes the originating MPI header 822 and footer 826, stores the resulting payload in its cache and/or memory 832, and examines the payload for instructions.

The instructions within the payload may designate that the MPI-aware switch 802 broadcast the payload to a second MPI-aware host 804, and a third MPI-aware host 806. In this embodiment, the MPI-aware switch can construct new MPI-wrapped messages, which can be respectively conveyed to MPI-aware host 804, and conveyed to MPI-aware host 804.

In another embodiment of the invention, the MPI-aware switch 802 can act as a translator between different MPI protocol implementations. In this embodiment, the MPI-aware switch 802 can be aware of, and can keep track of, each MPI-aware HPC node's associated MPI implementation. Furthermore, the MPI-aware switch 802 can contain lightweight MPI protocol stacks to understand the MPI-wrapped messages from one MPI-aware HPC node and translate the MPI-wrapped messages into the appropriate MPI implementation of the MPI-aware HPC node destination.

For example, a first MPI-aware host 800 wraps a payload 824 containing parallel applications and/or data to be enacted upon, the identity of the HPC operation, all potential MPI-aware HPC nodes and processes to be involved in the HPC operation, and the IDs assigned to each of those MPI-aware HPC nodes and processes, with an MPI header 822 and MPI footer 826 to create an MPI-wrapped message 820.

The resulting MPI-wrapped message 820 is then conveyed to an MPI-aware switch 802 which accepts the MPI-wrapped message, removes the originating MPI header 822 and footer 826, stores the resulting payload in its cache and/or memory 832, and examines the payload for instructions. The instructions within the payload may designate that the MPI-aware switch 802 broadcast the payload to a second MPI-aware host 804, and a third MPI-aware host 806.

In this embodiment, a second MPI-aware host 804 may have a different MPI protocol implementation than the first MPI-aware host 802, and a third MPI-aware host 806 may have yet a different MPI protocol implementation than the first MPI-aware host 802, and the second MPI-aware host 804. If that is the case, the MPI-aware switch 802 can construct a new translation of one or more new MPI-wrapped messages, using the MPI protocol implementations associated with MPI-aware host 804. Once the new MPI-wrapped messages, each with a different MPI protocol implementation, are constructed, they can be respectively conveyed to MPI-aware host 804, and conveyed to MPI-aware host 804.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

At a minimum, use of the method and apparatus of the invention can result in reduced message-passing protocol communication overhead when interconnect traffic is intensive between a plurality of computing nodes, which can improve HPC cluster performance and MPI host-to-host scalability. Furthermore, the present invention can enable an intelligent, cache-based HPC appliance capable of receiving a single MPI-wrapped message and broadcasting copies of it to multiple MPI-aware HPC node destinations, and acting as a translator between different MPI implementations at different MPI-aware HPC cluster network nodes.

Although the present invention has been described in detail, it should be understood that various changes, substitutions and alterations can be made hereto without departing from the spirit and scope of the invention as defined by the appended claims.

What is claimed is:

1. A system for passing messages between a plurality of information handling systems in a computing network, comprising:
a switch operably connected to said network to control message passing between said information handling systems;
wherein said switch is operable to implement a message-passing interface (MPI) protocol; and
wherein said switch is further operable to receive a message in a first message passing library format from a first information handling system and to transmit said message in a second message passing format to a second information handling system.

2. The system of claim 1, wherein said switch is aware of message passing library protocols implemented on said plurality of information handling systems within said plurality of information handling systems.

3. The system of claim 2, wherein said MPI protocol is a lightweight implementation of MPI primitives resident on the switch.

4. The system of claim 3, wherein said MPI primitives bypass intermediate layers in a communication protocol stack and convey MPI commands directly to the NIC to wrap messages with a header and a footer that can be interpreted by said information handling systems.

5. The system of claim 2, wherein said first and second message passing library formats for information handling systems in said predetermined set are identical.

6. The system of claim 2, wherein:
a first information handling system generates a message in said first message passing library format and said switch translates said message to conform to said second message passing library format.

7. A method for passing messages between information handling systems in a network, comprising:
using a switch comprising a network interface controller to control message passing between said information handling systems;
wherein said switch is operable to implement a message-passing interface (MPI) protocol; and
wherein said switch is further operable to receive a message in a first message passing library format from a first information handling system and to transmit said message in a second message passing format to a second information handling system.

8. The method of claim 7, wherein said switch is aware of message passing library protocols implemented on said plurality of information handling systems within said plurality of information handling systems.

9. The method of claim 8, wherein said MPI protocol is a lightweight implementation of MPI primitives resident on the switch.

10. The method of claim 9, wherein said MPI primitives bypass intermediate layers in a communication protocol stack, and convey MPI commands directly to a network interface controller to wrap messages with a header and a footer that can be interpreted by said information handling systems.

11. The method of claim 8, wherein said first and second message passing library formats for information handling systems in said predetermined set are identical.

12. The method of claim 8, wherein:
a first information handling system generates a message in said first message passing library format and said switch translates said message to conform to said second message passing library format.

13. A system for passing messages between a plurality of information handling systems in a computing network, comprising:
a switch comprising a network interface controller, said switch being operably connected to said network to control message passing between said information handling systems;
wherein said switch is operable to implement a message-passing interface (MPI) protocol;
wherein said switch is operable to use a routing table to obtain information relating to said plurality of information handling systems; and
wherein said switch is further operable to receive a message in a first message passing library format from a first information handling system and to transmit said message in a second message passing format to a second information handling system.

14. The system of claim 13, wherein said switch is operable to discover the presence of information handling systems on said network by conducting a protocol sweep.

15. The system of claim 13, wherein said switch is operable to discover the presence of information handling systems on said network by analyzing subnet data parameters.

16. The system of claim 13, wherein said switch is operable to discover the presence of information handling systems on said network by analyzing a network table.

17. The system of claim 13, wherein said switch is operable to analyze the operating condition of information handling systems on said network.

18. The system of claim 17, wherein said switch analyzes the operating condition of said information handling systems by performance monitoring.

19. The system of claim 17, wherein said switch analyzes the operating condition of said information handling systems using an event log.

20. The system of claim 17, wherein said switch analyzes the operating condition of said information handling systems using an agent.
